(19) United States
(12) Patent Application Publication
(10) Pub. No.: US 2017/0031178 A1
(43) Pub. Date: Feb. 2, 2017

(54) SPECTACLE FRAME

(71) Applicant: BOSTON CLUB CO., LTD., Fukui (JP)

(72) Inventor: Kazumi KOMATSUBARA, Fukui (JP)

(21) Appl. No.: 15/211,125

(22) Filed: Jul. 15, 2016

(30) Foreign Application Priority Data
Jul. 27, 2015 (JP) 2015-147349

(51) Int. Cl. G02C 5/20; G02C 5/00; G02C 11/00; G02C 5/14

(52) U.S. Cl. CPC G02C 5/20; G02C 5/146; G02C 5/006; G02C 11/00

(57) ABSTRACT

A spectacle frame includes a first member and a second member. The first member and the second member are expandably and foldably connected, and configured to be expanded when in use. The first member includes a frame fitting part. The frame fitting part is configured to be fitted to a device fitting part of a device, so that the device may be mounted on the spectacle frame.

Priority is claimed on Japanese Patent Application No. 2015-147349 filed on Jul. 27, 2015, the content of which is incorporated herein by reference.

### TECHNICAL FIELD

The present invention is related to a spectacle frame.

### BACKGROUND ART

JP 2015-96929 A and JP 2014-81481 A disclose devices used with spectacles. The device may include various elements, such as a computer, a display, a projector, a sensor, a camera, a microphone, a battery or a light. The device may display or project various information complementing a real world, such as a root guide to a destination, a translation of foreign language, or profile of a human in front. A plurality of devices may be used with a pair of spectacles. The device may be integrally formed with a spectacle frame, or removably mounted on the spectacle frame.

### SUMMARY OF INVENTION

### Technical Problem

Generally, a fixing member, such as a screw, is used for stably fixing a removable device to a spectacle frame. However, it may be hard to remove the device stably fixed with the fixing member.

The present invention aims to stably fix a device to a spectacle frame, and to ease removing the device from the spectacle frame.

### Solution to Problem

A spectacle frame according to the present invention includes a first member and a second member. The first member and the second member are expandably and foldably connected, and configured to be expanded when in use. The first member includes a frame fitting part. The frame fitting part is configured to be fitted to a device fitting part of a device, so that the device may be mounted on the spectacle frame.

The second member may be configured to block fitting and releasing of the frame fitting part and the device fitting part when expanded, and to allow the fitting and the releasing when folded.

The first member may includes an end face. The end face may be configured to be exposed when the first member and the second member are folded, and to be covered with the second member when the first member and the second member are expanded. The frame fitting part may be configured to be fitted to the device fitting part through the end face.

One of the first member and the second member may be a front. The other of the first member and the second member may be a temple.

The first member and the second member may be parts of a temple.

One of the first member and the second member may be a distal end part of a temple. The distal end part may be configured to be folded upward.

### Advantageous Effects of Invention

When in use, the first member and the second member are expanded. Thereby, fitting and releasing of the frame fitting part and the device fitting part is blocked. This makes the device to be stably fixed to the spectacle frame. When the first member and the second member are folded, the fitting and the releasing are allowed. This makes it easy to remove the device from the spectacle frame.

Covering the end face with the second member in an expanded state enables to block the fitting and the releasing. Exposing the end face in an folded state enables to allow the fitting and the releasing.

Using connection between the front and the temple eliminates requirement of additional parts.

Dividing the temple enables to mount the device at the middle of the temple.

### BRIEF DESCRIPTION OF DRAWINGS

FIGS. 1 and 2 show a plan view and a front view of a spectacle frame with a device according to an embodiment.

FIGS. 3 and 4 show a plan view and an enlarged IV-IV section view of the device according to the embodiment.

FIGS. 5 and 7 show partially sectional plan views of the spectacle frame according to the embodiment.

FIG. 6 shows an enlarged VI-VI section view of the spectacle frame according to the embodiment.

FIGS. 8 and 9 show enlarged section views of a spectacle frame and a device according to another embodiment.

FIGS. 10 and 11 show a plan view and a side view of a spectacle frame with a device according to another embodiment.

FIGS. 12 to 14 show a plan view, a side view and an enlarged XIV-XIV section view of the device according to the embodiment.

FIGS. 15 to 17 show a plan view, a side view and an enlarged XVII-XVII section view of the spectacle frame according to the embodiment.

FIGS. 18 and 19 show a plan view and a side view of a spectacle frame with devices according to another embodiment.

FIGS. 20 and 21 show side views of the devices according to the embodiment.

FIG. 22 shows a side view of the spectacle frame according to the embodiment.

### EMBODIMENTS

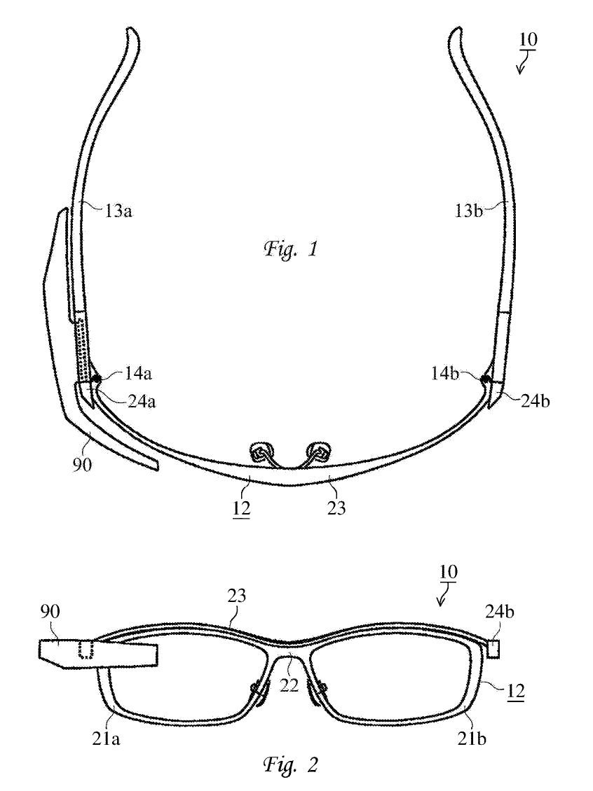

As shown in FIGS. 1 and 2, a spectacle frame 10 according to an embodiment can be used with a device 90. The device 90 is mounted on the spectacle frame 10, so as to be stably fixed to the spectacle frame 10. The device 90 can be easily removed from the spectacle frame 10.

The spectacle frame 10 is made of plastics, metal or the like, and includes a front 12, two temples 13a and 13b, and two joints 14a and 14b. The front 12 includes two rims 21a and 21b, a bridge 22, a top bar 23, and two end pieces 24a and 24b. The joint 14a connects the temple 13a to the front 12. The temple 13a can pivot on the joint 14a. The joint 14b connects the temple 13b to the front 12. The temple 13b can pivot on the joint 14b.

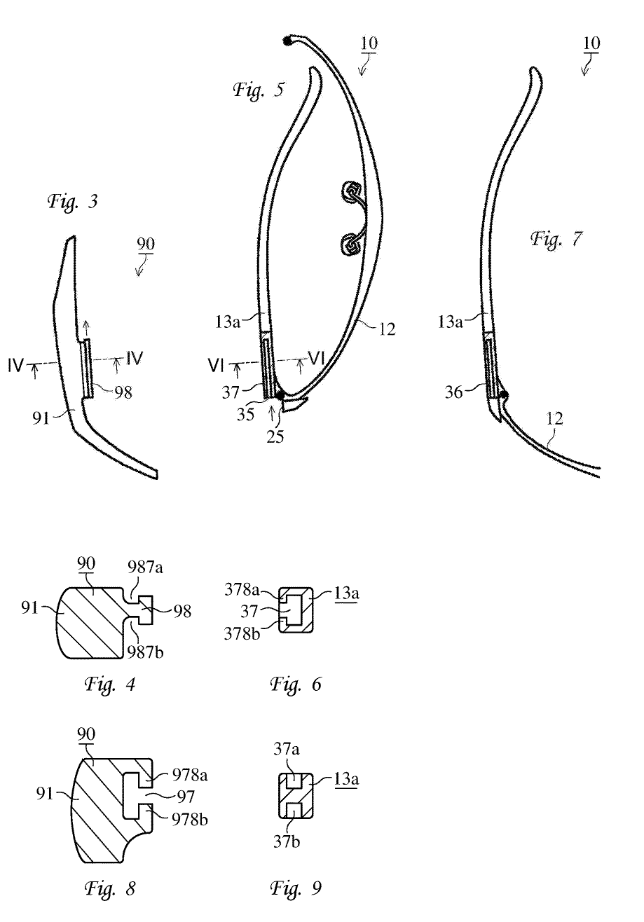

As shown in FIGS. 3 and 4, the device 90 includes a body 91 and a guide projection 98 (device fitting part). The guide projection 98 is elongated and protrudes inward from the body 91. The guide projection 98 has two grooves 987a and 987b, which makes its root narrower than its top.

As shown in FIGS. 5 and 6, the front 12 (second member) includes an end face 25, and the temple 13a (first member) includes an end face 35 and a guide groove 37 (frame fitting part). The guide groove 37 is elongated and recessed from an outer side face of the temple 13a. The guide groove 37 has two projections 378a and 378b, which makes its opening narrower than its bottom. The guide groove 37 is connected to the end face 35. That is, the guide groove 37 has another opening on the end face 35.

The guide groove 37 can be fitted to the guide projection 98, so that the device 90 can be stably fixed to the spectacle frame 10. The guide groove 37 is preferably to have a length substantially the same as that of the guide projection 98. The guide projection 98 can be inserted into the guide groove 37 through the opening on the end face 35, but cannot be inserted from other directions. Also, the guide projection 98 fitted to the guide groove 37 can be extracted from the guide groove 37 through the opening on the end face 35, but cannot be extracted toward other directions.

In a folded state shown in FIG. 5, the end faces 25 and 35 are apart. That is, the end face 35 is exposed. This allows insertion of the guide projection 98 into the guide groove 37, and extraction of the guide projection 98 from the guide groove 37. Thus, the device 90 can be easily removed from the spectacle frame 10.

In an expanded state shown in FIG. 7, the end faces 25 and 35 face one other. That is, the end face 35 is covered. This blocks insertion of the guide projection 98 into the guide groove 37, and extraction of the guide projection 98 from the guide groove 37. Thus, the device 90 can be stably fixed to the spectacle frame 10.

In this manner, the spectacle frame 10 allows easy mounting and removal of the device as required. A fixing member such as a screw is not needed. When the device is removed, it can be used as a usual spectacles.

As shown in FIG. 8, a device 90 according to another embodiment includes a guide groove 97 (device fitting part). The guide groove 97 is recessed from an inner side face of a body 91. The guide groove 97 has two projections 978a and 978b, which makes its opening narrower than its bottom.

As shown in FIG. 9, a temple 13a includes two guide grooves 37a and 37b (frame fitting part). The guide groove 37a is recessed from a top face of the temple 13a. The guide groove 37b is recessed from a bottom face of the temple 13a. The guide groove 37a can be fitted to the projection 978a. The guide groove 37b can be fitted to the projection 978b.

This configuration also enables stable fixing of the device 90 to the temple 13a in the expanded state, and easy removal of the device 90 from the temple 13a in the folded state.

In this manner, the frame fitting part may have any shape enabling fitting to the device fitting part and stable fixing of the device. The frame fitting part is not limited to a groove. It may be a projection, or may have other shapes.

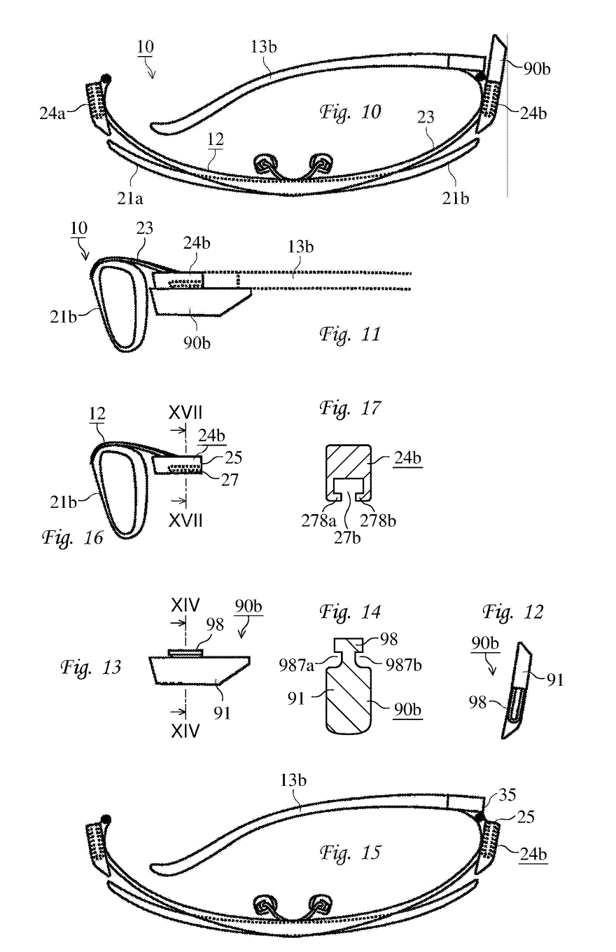

As shown in FIGS. 10 and 11, a spectacle frame 10 according to another embodiment allows a device 90b to be mounted on a left side. The spectacle frame 10 also allows a device to be mounted on a right side.

The spectacle frame 10 includes a front 12 and two temples 13a and 13b. The temple 13a is omitted in the figure. The front 12 includes two rims 21a and 21b, a top bar 23, and two end pieces 24a and 24b.

As shown in FIGS. 12 to 14, the device 90b includes a body 91 and a guide projection 98 (device fitting part). The guide projection 98 is elongated and protrudes upward from the body 91. The guide projection 98 has two grooves 987a and 987b, which makes its root narrower than its top.

As shown in FIGS. 15 to 17, the temple 13b (second member) includes an end face 35, and the end piece 24b (first member) includes an end face 25 and a guide groove 27 (frame fitting part). The guide groove 27 is elongated and recessed from an bottom face of the end piece 24b. The guide groove 27 has two projections 278a and 278b, which makes its opening narrower than its bottom. The guide groove 27 is connected to the end face 25. That is, the guide groove 27 has another opening on the end face 25.

The guide groove 27b can be fitted to the guide projection 98, so that the device 90 can be stably fixed to the spectacle frame 10. The guide projection 98 can be inserted into the guide groove 27b through the end face 25, but cannot be inserted from other directions. Also, the guide projection 98 fitted to the guide groove 27b can be extracted from the guide groove 27b through the end face 25, but cannot be extracted toward other directions.

In a folded state, the end faces 25 and 35 are apart. That is, the opening on the end face 25 is exposed. This allows insertion of the guide projection 98 into the guide groove 27b, and extraction of the guide projection 98 from the guide groove 27b. Thus, the device 90 can be easily removed from the spectacle frame 10.

In an expanded state, the end faces 25 and 35 face one other. That is, the opening on the end face 35 is closed. This blocks insertion of the guide projection 98 into the guide groove 27b, and extraction of the guide projection 98 from the guide groove 27b. Thus, the device 90 can be stably fixed to the spectacle frame 10.

In this manner, the frame fitting part may be provided on the front 12, and the temple may block the extraction.

The end piece 24a has a shape similar to the end piece 24b.

In this manner, the spectacle frame 10 may include two frame fitting parts.

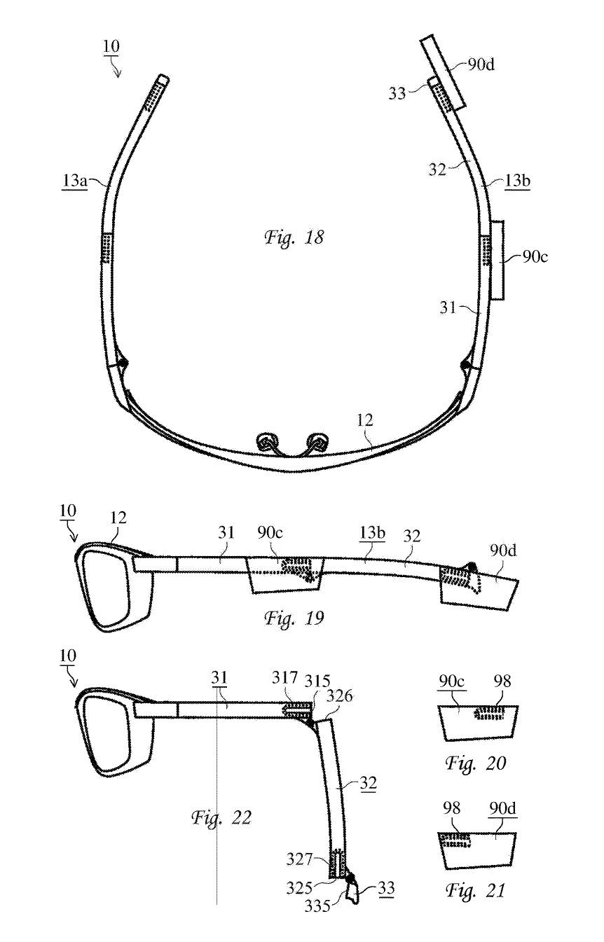

As shown in FIGS. 18 and 19, a spectacle frame 10 according to another embodiment allows two devices 90c and 90d to be mounted on a left side. The spectacle frame 10 also allows two devices to be mounted on a right side.

The spectacle frame 10 includes a front 12 and two temples 13a and 13b. The temple 13b includes three parts 31 to 33. The first part 31 has a first end connected to the front 12. The second part 32 has a first end connected to a second end of the first part 31. The third part 33 is a distal end part of the temple 13b, and is connected to a second end of the second part 32.

As shown in FIG. 20, the device 90c includes a guide projection 98 (device fitting part).

As shown in FIG. 21, the device 90d also includes a guide projection 98 (device fitting part).

As shown in FIG. 22, the first part 31 (first member) includes an end face 315 and a guide groove 317 (frame fitting part). The guide groove 317 is connected to the end face 315. The guide groove 317 can be fitted to the guide projection 98 of the device 90c.

The second part 32 (second member; another first member) can pivot downward against the first part 31. The second part 32 includes two end faces 325 and 326, and a guide groove 327 (another frame fitting part). In folded state, the end face 326 leaves and exposes the end face 315, which allows the guide projection 98 to fit the guide groove 317. In expanded state, the end face 326 abuts and covers the end face 315, which blocks the guide projection 98 to be extracted from the guide groove 317. The guide groove 327 can be fitted to the guide projection 98 of the device 90d.

The third part 33 (another second member) can pivot upward against the second part 32. The third part 33 includes an end face 335. In folded state, the end face 335 leaves and exposes the end face 325, which allows the guide projection 98 to fit the guide groove 327. In expanded state, the end face 335 abuts and covers the end face 325, which blocks the guide projection 98 to be extracted from the guide groove 327.

When in use, the second part 32 is placed on wearer's ear. This achieves close contact between the end faces 315 and 326. And a weight of the third part 33 realizes close contact between the end faces 325 and 335. Thereby, the devices 90c and 90d can be stably fixed to the spectacle frame 10.

Even when the spectacle frame 10 is worn, the third part 33 can be folded, which enables mounting and removal of the device 90d.

In this manner, the temple may be divided, and the frame fitting part may be provided in the middle of the temple. One temple may include two or more frame fitting parts.

The temple 13a has a structure similar to the temple 13b.

In this manner, the spectacle frame 10 may includes three or more frame fitting parts.

The device may be an ornament without special functions, or may be used for hiding the frame fitting part. This improves decorativeness of the spectacle frame.

The above described embodiments are examples to make it easier to understand the present invention. The present invention is not limited to the example, and includes any modified, altered, added, or removed variations, without departing from the scope of the claims attached herewith. This can be easily understood by persons skilled in the art.

For example, the spectacle frame may be a half rim type, or a rimless type.

### REFERENCE SIGNS LIST

10: spectacle frame; 12: front; 13a and 13b: temple; 14a and 14b: joint; 21a and 21b: rim; 22: bridge; 23: top bar; 24a and 24b: end piece; 25, 35, 315, 325, 326 and 335: end face; 27, 37, 37a, 37b, 97, 317 and 327: guide groove; 278a, 278b, 378a, 378b, 978a and 978b: projection; 31: first part; 32: second part; 33: third part; 90, 90b, 90c and 90d: device; 91: body; 98: guide projection; and 987a and 987b: groove.

1. A spectacle frame, comprising a first member and a second member, wherein
the first member and the second member are expandably and foldably connected, and configured to be expanded when in use,
the first member comprises an end face and a frame fitting part,
the end face is configured to be exposed when the first member and the second member are folded, and to be covered with the second member when the first member and the second member are expanded, and
the frame fitting part is configured to be fitted to a device fitting part of a device through the end face, so that the device may be mounted on the spectacle frame.

2. The spectacle frame of claim 1, wherein one of the first member and the second member is a front, and the other of the first member and the second member is a temple.

3. The spectacle frame of claim 1, wherein the first member and the second member are parts of a temple.

4. The spectacle frame of claim 3, wherein one of the first member and the second member is a distal end part of a temple, and the distal end part is configured to be folded upward.

5. A spectacle frame, comprising a first member and a second member, wherein
the first member and the second member are expandably and foldably connected, and configured to be expanded when in use,
the first member comprises a frame fitting part,
the frame fitting part is configured to be fitted to a device fitting part of a device, so that the device may be mounted on the spectacle frame, and
the second member is configured to block fitting and releasing of the frame fitting part and the device fitting part when expanded, and to allow the fitting and the releasing when folded.

6. The spectacle frame of claim 5, wherein one of the first member and the second member is a front, and the other of the first member and the second member is a temple.

7. The spectacle frame of claim 5, wherein the first member and the second member are parts of a temple.

8. The spectacle frame of claim 7, wherein one of the first member and the second member is a distal end part of a temple, and the distal end part is configured to be folded upward.
